(19) United States
(12) Patent Application Publication
(10) Pub. No.: US 2011/0066857 A1
(43) Pub. Date: Mar. 17, 2011

(54) Method for secure delivery of digital content

(76) Inventors: David K. Probst, Montreal (CA); Mark Alan Sturza, Encino, CA (US)

(21) Appl. No.: 12/803,842

(22) Filed: Jul. 6, 2010

Related U.S. Application Data
(63) Continuation-in-part of application No. 09/887,570, filed on Jun. 22, 2001, now abandoned.

(51) Int. Cl. H04L 9/32

(52) U.S. Cl. 713/170

(57) ABSTRACT

Methods and apparatus for the secure and copy-proof distribution of digital content are disclosed. In a preferred embodiment of the invention cryptographic primitives (encryption algorithms, message-authentication codes, hash functions, random-number generators, etc.) are used in a novel security protocol. The invention may be utilized to protect a first-run movie that has been digitized in accordance with one of the current or forthcoming MPEG standards (e.g., MPEG-7). Content receivers or users first register their boxes. This registration information is stored in a secure database. When a subscriber registers, he then receives a box (interface to his player) that has been initialized to contain a number of tamper-proof secrets that are shared between the station and that particular box. The station stores an encrypted version of the digital content. This encrypted version ultimately arrives at some unprotected storage medium local to the player. Upon demand, the station delivers to the box the use-once computational ability to decrypt the content and display it on the player or terminal.

### CROSS-REFERENCE TO A RELATED PATENT APPLICATION & CLAIM FOR PRIORITY

The Present Patent Application is a Continuation-in-Part Patent Application, and is related to a Parent Patent Application entitled Method for Secure Delivery of Digital Content, U.S. Ser. No. 09/887,570, filed on 22 Jun. 2001. The Applicants hereby claim the benefit of priority under 35 USC Sections 119 & 120 for any subject matter which is commonly disclosed in both U.S. Ser. No. 09/887,570 and the Present Patent Application.

### FEDERALLY SPONSORED RESEARCH OR DEVELOPMENT

None.

### FIELD OF THE INVENTION

The present invention pertains to methods and apparatus for insuring the security of digital content. More particularly, one preferred embodiment of the invention provides copy protection for digital content that is displayed or recreated on a player or terminal of an end user.

### BACKGROUND OF THE INVENTION

Content providers are increasingly storing and distributing their intellectual property (i.e., the content) in digitized form, and are justifiably concerned about the possibility that this content may be misappropriated. Conventional security methods encrypt the digital content, transmit the content to the user, and trust the user's player or terminal to decrypt it in a secure fashion. Many of these conventional security methods may easily be broken, because they utilize weak proprietary or open source cryptographic algorithms, and protocols that are easily broken by hackers of moderate skill who promptly publish their results, nullifying the original security system.

At the present time, none of the security systems which are available in the commercial market can provide reliable copy protection. The development of such a system would constitute a major technological advance, and would satisfy long felt needs and aspirations in the both the content producing (entertainment, games, software, etc.) and telecommunications (telephone, cable, satellite networks, etc.) industries.

### SUMMARY OF THE INVENTION

The present invention supplies a means of copy protection for digital content. In one embodiment of the invention, all responsibility for copy protection has been removed from the user's player or terminal. All the security features are removed from the player, and placed in a secure “box.” The box incorporates security protocols that use strong cryptographic algorithms as primitives to insure that the security furnished by the module cannot be broken.

In one embodiment, a delivery source or station sends the bounded-time computational ability to display the content separately from the digital content, and then self-destructs. The division of labor between station and box means that unusually strong encryption algorithms may be employed, and while keeping the cost of manufacture of the box low since they require relatively little processing power. When the box is purchased, a registration process enters a security protocol.

The present invention offers a distributed end-to-end system/security architecture that is completely independent of the communications media which is employed. The present invention may be utilized to secure or protect any digital content, including high value files that contain movies or music which are transported over a network, or which are stored on a physical medium such as a DVD or CD.

An appreciation of the other aims and objectives of the present invention and a more complete and comprehensive understanding of this invention may be obtained by studying the following description of a preferred embodiment, and by referring to the accompanying drawings.

### A BRIEF DESCRIPTION OF THE DRAWING

FIG. 1 is a schematic diagram of one embodiment of the present invention.

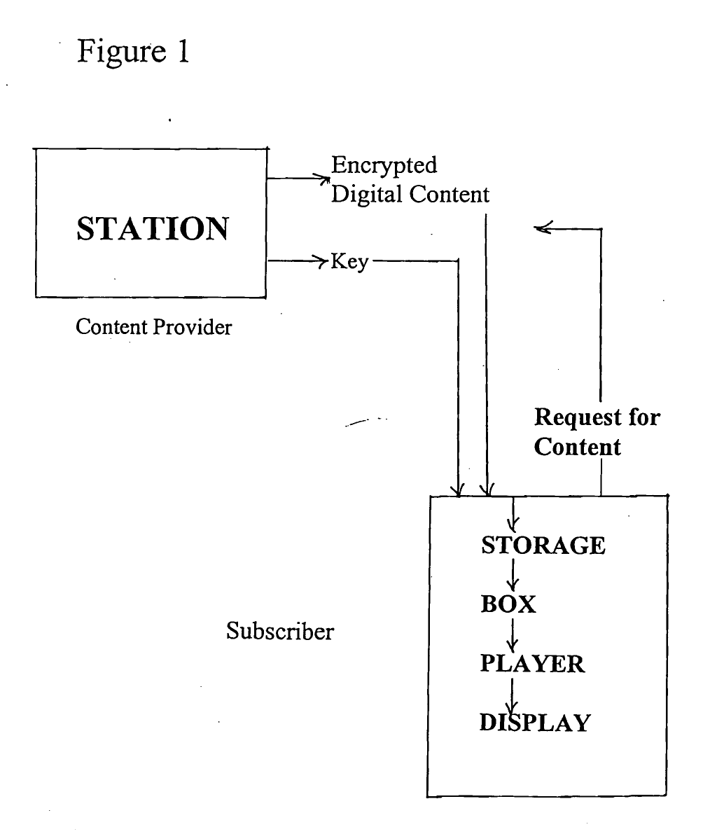

FIG. 2 is a schematic diagram of one embodiment of the box.

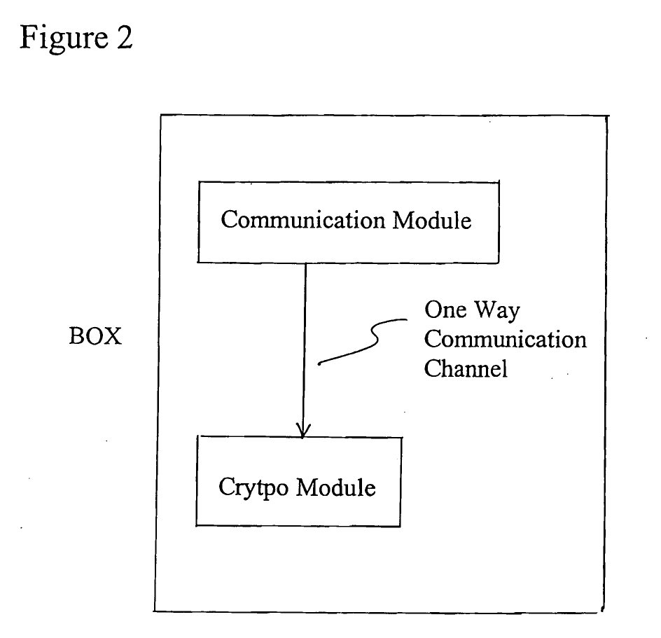

### A DETAILED DESCRIPTION OF PREFERRED & ALTERNATIVE EMBODIMENTS

### Overview of the Invention

One embodiment of the invention comprises a method for copy protection for the owner of digital content that is displayed on a user's player or terminal. The responsibility for copy protection is removed from the player, and is placed inside an appliance or terminal in a secure “box.”

In a preferred embodiment of the invention, cryptographic primitives (encryption algorithms, message-authentication codes, hash functions, random-number generators, etc.) are used in a novel security protocol together with a novel key exchange protocol. The invention may be utilized to protect a first-run movie that has been digitized in accordance with one of the current or forthcoming standards (e.g., MPEG). Content receivers or users first register their boxes. This registration information is stored in a secure database. When a subscriber registers, he then receives a box (interface to his player) that has been initialized to contain a number of tamper-proof secrets that are shared between the station and that particular box. The station stores an encrypted version of the digital content. This encrypted version ultimately arrives at some unprotected storage medium local to the player. Upon demand, the station delivers to the box the use-once computational ability to decrypt the content and display it on the player or terminal.

The box is configured for a computational workload that allows them to be manufactured relatively cheaply. The station is configured for a computational workload that allows it to keep pace with what might be one million simultaneous requests for service from one million boxes. In one embodiment, the box is a modest-sized information appliance, while a station comprises a cluster of workstations (or equivalent) as the number of boxes per station grows. Initial encryption of the digital content and security-domain initialization of station and box both count as precomputation.

The encrypted content or ciphertext is stored on some removable or fixed storage medium within the user's player. The subscriber then requests the content provider to supply a “key” which enables the box to play or the content. This request will may require a payment from the subscriber to the content provider. Once the content provider is paid, or approval to decrypt the content stored in the user's box is granted, the station supplies the transient computational ability to display the content once. The word “transient” is used here because the computational ability self-destructs as it is used. The subscriber may issue as many requests for use-once computational ability to display this movie as he desires; this resembles “pay per view” with higher-value digital content. The invention may employ multiple time sensitive keys which vanish as soon as they are used.

The present invention may be utilized to secure or protect any digital content, including high value files that contain movies or music which are transported over a network, or which are stored on a physical medium such as a DVD or CD.

One embodiment of the invention includes:
encrypting digital content;
establishing a priori shared secrets between a station and a box by tamper-proof burning of secret information into boxes prior to their registration;
creating a security protocol to deliver the transient computational ability to a given box to display the encrypted digital content precisely once (this ability self-destructs as it is used); and
designing the box system architecture, with particular attention paid to physical-security issues (the box's physical-security perimeter must be implemented by hardware means within the box).

### Encryption

Before the subscriber can obtain content, such as a copy of an encrypted digital film, it must first have been encrypted. This encryption must offer extremely high-assurance confidentiality, and be susceptible of decryption by equipment used by the subscriber. In one embodiment of the invention, an appropriate strong encryption algorithm is selected. For encryption of large files containing high-value digital content, a choice must be made among various methods, including symmetric-key, asymmetric-key and public-key cryptography. The throughput rates for the most popular public-key encryption methods are several orders of magnitude slower than the best-known symmetric-key schemes. All operational systems use a hybrid approach that utilize both kinds of cryptography. Specifically, public-key schemes are used only for cryptographic-key exchange, while the more efficient private-key schemes are used for actual encryption and decryption of digital content. In one embodiment of the invention, no cryptographic keys are ever public per se; at most, some of them are published in a secure fashion within an individual security group. Symmetric-key methods can be quite strong.

In one embodiment of the invention, the symbol “M” is used to represent a file containing a first-run movie that has been digitized according to some MPEG standard. In this particular instance, the MPEG standard also defines the decryption throughput that must be achieved by the box in order that the decrypted signal may be injected into the subscriber's player or terminal at the expected rate. (This example assumes on-the-fly decryption).

File M is divided into ‘s’ fixed-size segments, where ‘s’ is chosen by the security architect. Segments are portions of a file, such as a movie. By increasing the value of ‘s’, the amount of plaintext that is encrypted can be limited by any one cryptographic key. The trade-off here is between unusually high degrees of assurance, and the number of keys that must be exchanged between station and box during one key-exchange protocol. The present invention has been designed with any number of parameters so that security may be increased. In general, when the level of security is increased, the performance decreases. The majority of the key-exchange work is borne by the station, and is, therefore, limited only by computing power of the station.

At this point in the process, file M is a sequence of plaintext segments <b_j>, 1<=j<=s. Each film segment b_j is encrypted using the Rijndael symmetric-key encryption algorithm, which is the new Federal Advanced Encryption Standard (AES). Rijndael is superior to the unclassified symmetric-key algorithms it replaces in both security and performance. In one embodiment, both the block length and the key length are chosen to be 256 bits.

Since Rijndael is a block cipher, and since it is unlikely that the length of a film segment b_j is less than or equal to 256 bits, Rijndael must be combined with an appropriate cipher-block chaining strategy such as Cipher Block Chaining (CBC). Several choices are available. A different 256-bit Rijndael key k_j is used to encrypt each film segment b_j, 1<=j<=s. The ciphertext corresponding to b_j is denoted c_j. The division into segments increases the strength of the encryption, by encrypting less plaintext with a given key, and also provides great flexibility in the decoding strategy.

No special care is required in selecting Rijndael keys. In one embodiment of the invention, keys are selected using a method that prevents a hacker from breaking the security of the system. A random-number generator or other mechanism may be employed, as long as the keys are generally unpredictable and irreproducible. In one embodiment, the 256-bit keys are genuinely random numbers produced by physical processes such as electrically noisy diodes. Genuinely random numbers are used as Rijndael keys, not to make Rijndael run better, nor to prevent a hacker from breaking the security of the system, but, rather, to open up entirely new key-exchange and/or key-determination possibilities.

After encryption, the encrypted-film file M'=<c_j>, 1<=j<=s, and the film-segment-key file K=<k_j>, 1<=j<=s. Both encrypted-film file M' and film-segment-key file K are stored securely in the station. The plaintext file M is no longer required.

### Registration & Initialization

The second component concerns the initialization of both station A and box B where there is one station A and many boxes B. Some station initialization is done once for all boxes in the security domain, and some is done on a per-box basis. Box initialization becomes “valid” as soon as the box has been registered with the security domain.
1) A box-independent public-key cryptosystem is constructed for station A based on the RSA™ cryptosystem, but using quasi-public keys. The symbols ‘p’ and ‘q’ are employed to denote two large distinct primes. The symbol n=p*q. The set of plaintexts and the set of ciphertexts are both equal to the finite ring Z_n. Any message too long to belong to Z_n is dealt with by Cipher Block Chaining (CBC). Two exponents ‘e’ and ‘d’ are constructed such that exponentiation by one exponent modulo n is the inverse of exponentiation by the other exponent modulo n. One exponent, ‘pubA’, chosen small, is burned into each box registered with this station, along with the modulus In'. The other exponent, ‘priA’, which may be large, is a secret of station A. The key ‘pubA’ is a quasi-public key that is burned into each box B registered with A in a tamper-proof way so that ‘pubA’ is not recoverable from box B. The same holds true for modulus In'.

Any box B will raise numbers to the power ‘pubA’ modulo n to encrypt messages intended for station A and to verify digital signatures generated by station A. This is sufficient for a rapid authentication protocol that authenticates a given box B to station A provided that each box B is given a large, (for example, 256-bit) genuinely random string ‘idB’, which is a shared secret between A and B, that is a unique identifier for a given box B among all boxes registered with that station.

2) A box-independent large cyclic group is then constructed, in which the discrete-logarithm problem is intractable for station A. This can be done either with standard number theory or elliptic-curve techniques. One method that may be employed is to choose a large prime ‘p’, and then to use the multiplicative group of integers modulo p, i.e., Z*_p, as the cyclic group. Since ‘p’ is a prime number, there will be many primitive elements ‘x’ such that raising ‘x’ to successive powers will generate all the elements of the cyclic group. A primitive element modulo p has the same order as the cyclic group Z*_p, viz., p−1.

This additional machinery, on top of station A's long-lasting public-key cryptosystem, is used in the key-exchange protocol to generate session keys for encrypting the file-segment keys k_j, 1<=j<=s.

As an example, an appropriate prime ‘p’ and generator ‘alpha’ of Z*−p (2<=alpha<=p−2) is selected. Quasi-ElGamal key agreement may be achieved between station A and each one of one million boxes B as follows. For a given box B, A would normally need to reliably know the public key (p, alpha, alphâb) of B. In this example, station A has a cyclic group whose order is at least one million. Station A randomly and uniformly picks a distinct exponent ‘b’ 1<=b<=p−2, for each of the one million boxes it registers. Station A secretly computes and stores alphâb, for each box. As part of the registration process, exponent ‘b’ and prime ‘p’ are burned into the given box B (with a different ‘b’ for each distinct box B). When station A wishes to share a session key with a given box B, it randomly and uniformly picks an integer ‘x’ from the same range, and computes and transmits alphâx, called “elementA”, to box B. Station A computes (alphâb)̂x modulo p as the shared secret key, while box B computes elementÂb modulo p as the key, where, by construction, the keys are the same.

Considering just the first two components, after registration, a given box B must securely store:

1) the small integer ‘pubA’, which is station A's quasi-public key:
2) the RSA modulus In';
3) the 256-bit quantity ‘idB’ that uniquely identifies the given box B;
4) the 20-bit quantity ‘bB’, which probably should not be a small integer even though the adversary has no knowledge of prime ‘p’; and
5) the prime ‘p’ that is the modulus for the cyclic group Z*−p.

### Box System Architecture

In one embodiment of the invention, Box B comprises two distinct modules with an extremely narrow interface. The first module is a communications module, which may comprise a communications processor, a simplified file-transfer protocol, and a local disk. As a simpler alternative, the communications module may comprise a slot into which an encrypted DVD can be inserted along with a DVD reader. The second module is a crypto module that is responsible for the key-exchange protocol, and for the decryption of the encrypted digital content. The interface between the two modules is a one-way communications channel which enables the communications module to transmit the encrypted bitstream to the crypto module.

### The Physical Security of the Player

In one embodiment of the invention, the crypto module, which includes the key-exchange module and the decryption module, is provided with exceptional physical security. The crypto module is designed to be tamper-proof in a fail-safe way. Faraday cages may be used to eliminate leakage of van Eck radiation. Volatile storage, together with “erase on tamper,” must delete all keying information upon tampering with extremely high assurance. Finally, all microelectronics and wires are coated with “superglue,” which destroys the underlying circuitry if they are removed or disturbed.

The tap-proof line that runs out of the decryption module is also protected. Various anti-wiretapping strategies, including the use of piezoelectric materials, are employed used to signal the crypto module to “wipe clean.”

In one embodiment of the invention, the key-exchange module can deliver the file-segment keys k_j to the decryption module as plaintext. An alternative method employs the delivery of the Rijndael-encrypted k_j, along with their keys kk_j. The decryption module would then perform successive Rijndael decryptions to recover first the k_j and -then- the digital content.

Some of the properties of the box that is utilized in one embodiment of the invention are summarized below:

1) The communications module employs any communications medium to obtain the encrypted film: over the Internet, captured from a direct satellite broadcast, read in from a CD-ROM, etc. The encrypted file is stored on disk or some storage medium nearby.
2) The crypto module has the following features:
a) ‘idB’ and ‘pubA stored in box B allow cheap secure authentication of B to A
b) ‘bB’ stored in box B allows computation of the session key ‘S’ used to encrypt/decrypt the ‘s’ film-segment keys k_j 1<=j<=s. The computation by box B is S=elementÂbB modulo p, where ‘elementA’ is transmitted in plaintext from A to B, and “bB' and “p” are secrets of box B.

The station must deliver ‘s’ 256-bit keys k_j to the requesting box, which is 256*s bits altogether. But each of the k_j was chosen as a genuinely random number using some random physical process. It follows that the concatenation of all the keys k_j in ascending order is a plaintext of length 256* s bits with no redundancy whatsoever, unlike what would be expected if the plaintext were a human-comprehensible message expressed in a natural language such as English.

As their name indicates, one-time pads are never supposed to be used more than once because that would allow an adversary to exploit the redundancy of the underlying plaintext. Transmission of perfectly random plaintext allows the invention to realize efficiencies that are forbidden to ordinary plaintext.

Station A and a given box B have a fixed shared secret (the 256-bit quantity that uniquely identifies box B), and a variable shared secret which changes with every invocation of the key-exchange protocol by box B. In one embodiment, the variable shared secret is 20 bits long, but this could be bootstrapped (if necessary, by iteration) to become a longer shared secret.

Either the fixed shared secret or the variable shared secret (or some combination of the two) could be used as a one-time pad to encrypt the random plaintext along one-time-pad lines, in which both encryption and decryption are simple “exclusive or.”

In the remainder of this Specification, the 256-bit session key shall by used to perform a Rijndael encryption of the random plaintext constituted by the ‘s’ k_j.

3) ‘idB’ and ‘pubA’ (stored in permanent storage) lead to the construction of a session key ‘S’ for this one-time provision of the (self-destructive) computational ability of B to allow the player to display the film.
4) Session key IS' allows the Is' film-segment keys k_j 1<=j<=s, to be built up in temporary storage. They are encrypted and decrypted with session key ‘S’, using Rijndael. Since k_j at 256 bits is much smaller than a film segment, it may be possible to use a Rijndael key that is somewhat smaller than 256 bits. If Rijndael is used for both keys and film, both the key-exchange module and the decryption module can call on the same Rijndael decryptor submodule.
5) “Tamper proof” means that both temporary and permanent storage will be wiped clean if anyone attempts to open the crypto module. “Superglue,” piezoelectric techniques, and physical construction together provide layered “titanium-box” physical-security to the key-like material stored in box B.

### Key-Exchange Protocol

A brief description of the key-exchange protocol, where A is the station and B is one of one million boxes registered with the station, is provided below. Standard notation is used. A and B are legitimate parties.

“A->B: x” denotes the message x sent by A to B. Spoofing is possible so that B does not normally know if the message was indeed from A.
“1. A->B: x” denotes that which the protocol designer intended as the -first- message of the protocol. The trustworthiness of the external world cannot be assumed so this too must be independently verified.
“{x}k” means x encrypted under k.
“[x]k̂−1” means x signed under k̂−1 the key that “inverts” k. This notation recognizes that the key pairs used in cryptosystems come in pairs, where one key allows encryption and the other key (the same key in symmetric-key systems) allows decryption. The private decryption key is used to generate digital signatures.

### Description

Each key-exchange protocol step is followed by a description in simple English.
1. B->A: {Step1 (B to A), movie, idB, numberB, MAC}pubA
Box B initiates one instance of the key-exchange protocol with Station A by sending him this message. Box B identifies the protocol step, the movie, and provides his genuinely-random 256-bit unique identification number ‘idB’.
‘NumberB’ is the number of times this box has initiated this key-exchange protocol. ‘MAC’ is a message-authentication code implemented by a keyed hash function. The file is encrypted with station A's quasi-public key ‘pubA’. ‘NumberB’ will be incremented by one before this protocol is invoked by box B again.
2. A->B: <Step2 (A to B), elementA, numberB, MAC>
This message is sent in the clear with integrity and authentication checks. In particular, the message-authentication code (MAC) is [h(m)]priA, i.e., the hash of the entire message preceding the MAC digitally signed by station A. ‘NumberB’ could be camouflaged if this is desired. ‘ElementA’ is randomly selected by station A as an element of the large cyclic group managed by A. When box B receives this message, it is either discarded or else allows box B to compute the session key S=elementÂbB. At this point, both station A and box B share the secret session key ‘S’, which is unavailable to anyone else even though ‘elementA’ was sent in the clear.
3. B->A: {Step3 (B to A), ack}S
Box B acknowledges successful computation of session key ‘S’.
4. A->B: {Step4 (A to B), segment size, s}S
The station provides some information about the file.
5. A->B: {Step5 (A to B), j, k_j}S, for 1<=j<=s.
The station transmits all ‘s’ film-segment keys k_j to box B. Individual keys may be sent as separate messages or all keys may be sent as one long message. The conservative approach is to use a suitably-sized ‘S’ as a Rijndael key and encrypt each k_j, or the concatenation of all k_j, with the Rijndael algorithm.
6. B->A: {Step6 (B to A), ack}S
Box B acknowledges successful termination of this instance of the key-exchange protocol. Upon recovery of all the fragment keys k_j, session key ‘S’ is destroyed.

### Decryption of Digital Content

Box B has access to ‘s’ encrypted film-segments c_j, 1<=j<=s. He also has access (possibly all at once, possibly just in time) to ‘s’ Rijndael symmetric-key decryption keys k_j, 1<=j<=s. There is great flexibility at this point. Depending on the ability to buffer within the decryption module, the segments may be decrypted in sequential order, in some other order, or even in parallel.

In the simplest case, the fragments will be decoded r and sent in order to the player by secure cable. There is a clear division in time. When the box is freestanding from the player, the invention guards the plaintext MPEG signal up until it enters the player through the digital input port. As soon as key k_j is used to decrypt segment c_j, k_j is destroyed.

### Installation & Security of the Box

In one embodiment of the invention, the a customized cable is used to connect the crypto module to the subscriber's player. The box may be embedded inside the player. Any tampering with the cable or the connection to the digital input port causes a shutdown of the entire crypto module, and the erasure of all permanent and temporary storage within the crypto module. A description of other features of the box follows:

1) In permanent box storage, ‘idB’ and ‘bB’ must be protected with extreme care, i.e., the tamper-proof “titanium box” must guarantee that these two bit values cannot be captured even if the box is physically attacked.
2) The fragment keys k_j, 1<=k_j<=s, must be protected. Their physical presence inside the crypto module is relatively brief. The session key ‘S’ is also quite sensitive. It can be used after the fact to recover the k_j.
3) It may be preferable to use distinct session keys to encrypt distinct segment keys. This could improve flexibility and efficiency, as well as increase security.

### Applications in Gaming & Banking Environments

One embodiment of the present invention may be utilized in the gaming industry to manage gaming equipment. Some applications of this embodiment include the secure collection of data, maintaining gambling transactions, and distributing executable software files.

A second embodiment of the present invention may be utilized in the banking industry to secure and to manage transactions.

### CONCLUSION

Although the present invention has been described in detail with reference to one or more preferred embodiments, persons possessing ordinary skill in the art to which this invention pertains will appreciate that various modifications and enhancements may be made without departing from the spirit and scope of the Claims that follow. The various alternatives for providing a highly secure data distribution system that have been disclosed above are intended to educate the reader about preferred embodiments of the invention, and are not intended to constrain the limits of the invention or the scope of Claims. The List of Reference Characters which follow is intended to provide the reader with a convenient means of identifying elements of the invention in the Specification and Drawings. This list is not intended to delineate or narrow the scope of the Claims.

What is claimed is:

1. A method for conveying digital content comprising the steps of:
providing a server; said server being connected to a network;
providing a client; said client being connected to said network;
requesting a content key from said server;
authenticating said request;
sending an encrypted session key to said client;
decrypting said encrypted session key;
sending a second request to said server;
authenticating said second request;
sending said content key encrypted with said encrypted session key to said client;
using said encrypted session key to recover said content key; and
using said recovered content to decrypt digital content.

2. A method for conveying digital content comprising the steps of:
setting up a security domain on a server;
registering a client on said security domain;
said server generating a content key and encrypting said content with said content key;
said server transferring said encrypted content to said client;
said client sending a request to said server for said content key;
said server authenticating said request;
generating a session key;
encrypting said session key;
sending response to said client;
decrypting said response to recover said session key;
sending a second request to said server;
authenticating said second request;
encrypting said content key with said session key;
sending second response to said client;
decrypting said second response with said session key to recover said content key; and
using said content key to decrypt digital content.

3. A method for securely transferring digital contentnt comprising the steps of:
setting up a security domain on a server;
registering a client on said security domain;
dividing said digital content into a plurality of segments;
generating a plurality of segment keys, one for each of said plurality of segments;
encrypting each of said plurality of segments with one of said plurality of segment keys;
transferring said plurality of segments which have been encrypted to said client;
said client sending a request to said server for said plurality of segment keys;
authenticating said request;
generating a plurality of session keys, one for each of said plurality of segments;
encrypting said plurality of session keys;
sending a response to said client;
decrypting said response to recover said plurality of session keys;
sending a second request to said server;
authenticating said second request;
encrypting said remaining segment keys with said remaining session keys;
sending second response to said client;
decrypting said second response with said plurality of session keys to recover said plurality of segment keys which have been encrypted; and
using said plurality of segment keys to decrypt digital content.

4. A method for securely transferring digital content comprising the steps of:
setting up a security domain on a server including a quasi-public key crypto system and a quasi-public key, key exchange system;
registering a client on said security domain;
dividing digital content into a plurality of segments;
generating a random key for each segment;
encrypting said plurality of segments with said random keys using a symmetric key algorithm;
transferring said encrypted said plurality of segments to said client;
sending a request encrypted using said quasi-public key crypto system to said server for said segment keys;
authenticating said request for said segment keys from said client; generating session keys for each of said plurality of segments;
transforming said segment keys using said quasi-public key, key exchange protocol;
encrypting said transformed session keys using said quasi-public key crypto system;
sending response to said client;
decrypting said response using said quasi-public key crypto system;
recovering said session keys from said transformed session keys using said quasi-public key, key exchange protocol;
computing a hash of said session keys;
encrypting said hash using said symmetric key algorithm with said first session key;
sending a second request to said server;
authenticating said second request;
encrypting said remaining segment keys using said symmetric key algorithm with said remaining session keys;
sending second response to said client;
decrypting said second response using said symmetric key algorithm with said session keys to recover said encrypted segment keys; and
using said segment keys to decrypt digital content.

5. A method for conveying digital content comprising the steps of:
providing a server;
providing a client;
requesting a content key from said server;
authenticating said request;
sending an encrypted session key to said client;
decrypting said encrypted session key;
sending a second request to said server;
authenticating said second request;
sending said content key encrypted with said encrypted session key to said client;
using said encrypted session key to recover said content key; and
using said encrypted session key to decrypt digital content.
